(19) United States
(12) Patent Application Publication
(10) Pub. No.: US 2023/0122572 A1
(43) Pub. Date: Apr. 20, 2023

(54) VEHICLE ACCIDENT NOTIFICATION SYSTEM AND METHOD OF PROVIDING VEHICLE ACCIDENT NOTIFICATION SERVICE

(71) Applicant: Myren Inc., Siheung-si (KR)

(72) Inventor: Eun Hong Choi, Gwangmyeong-si (KR)

(73) Assignee: Myren Inc., Siheung-si (KR)

(21) Appl. No.: 17/935,760

(22) Filed: Sep. 27, 2022

(30) Foreign Application Priority Data
Oct. 15, 2021 (KR) 10-2021-0137046

(51) Int. Cl. H04W 4/90; H04L 51/02

(52) U.S. Cl. CPC H04W 4/90; H04L 51/02

(57) ABSTRACT

The present invention relates to a vehicle accident notification system and a method of providing a vehicle accident notification service. The vehicle accident notification system according to one embodiment of the present invention a user terminal that transmits accident data for notifying that a user is positioned inside a vehicle and an accident occurs; and a vehicle accident notification server receiving the accident data to transmit accident notification data for notifying an accident occurrence to a preset accident response organization, wherein, when the accident occurrence is detected during monitoring a status of the vehicle and a presence of an accident occurrence the user terminal transmits the accident data to the vehicle accident notification server.

### BACKGROUND OF THE INVENTION

### 1. Field of the invention

The present invention relates to a vehicle accident notification system and a method of providing a vehicle accident notification service, and more particularly, to a vehicle accident notification system and a method of providing a vehicle accident notification service, in which a vehicle accident is notified from a user terminal to a vehicle accident notification server upon occurrence of the accident, and the vehicle accident notification server notifies the accident, so as to rapidly perform a response to the accident.

### 2. Description of the Prior Art

In order to deal with a traffic accident in the related art, a driver may directly contacts the rescue team or the police, or another person, such as an opposite driver or an eyewitness, may notify the rescue team or the police of the accident situation.

However, in order for the driver to directly contact emergency contact networks for the rescue teams or police, or insurance companies, the driver may be required to take various actions in accordance with the traffic accident safety rules, and this may result in delaying the time for notifying the accident.

In particular, when a driver and passengers lose consciousness due to a vehicle accident in a lonesome situation such as at late night, early morning or on a remote road, reports are delayed due to few witnesses, thereby causing catastrophic events leading to death.

Accordingly, a real-time emergency rescue system platform for automatically report is required when the driver and passengers fail to report by themselves in a situation where there is no witness upon the vehicle accident.

### SUMMARY OF THE INVENTION

The present invention provides a vehicle accident notification system and a method of providing a vehicle accident notification service, in which a vehicle accident is notified from a user terminal to a vehicle accident notification server upon occurrence of the accident, and the vehicle accident notification server notifies the accident, so that a response to the accident may be rapidly performed.

In addition, the present invention provides a vehicle accident notification system and a method of providing a vehicle accident notification service, in which an accident is automatically notified to a vehicle accident notification server when a transmission-standby status maintaining time preset for waiting for transmitting data has elapsed upon occurrence of the accident, so as to respond to the accident.

An aspect of the present invention provides a vehicle accident notification system for notifying an occurrence of an accident to a preset accident response organization upon the accident, which includes: a user terminal that transmits accident data for notifying that a user is positioned inside a vehicle and an accident occurs; and a vehicle accident notification server that transmits accident notification data for notifying an accident occurrence to a preset accident response organization when the accident data is received, wherein the user terminal transmits the accident data to the vehicle accident notification server when the accident occurrence is detected during monitoring a status of the vehicle and a presence of the accident occurrence.

In addition, the user terminal may be provided to transmit the accident data when a transmission-standby status maintaining time preset for waiting for data transmission is elapsed after the accident occurrence is detected.

Another aspect of the present invention provides a method of providing a vehicle accident notification service to transmit a vehicle accident occurrence to a preset accident response organization by using a vehicle accident notification server, and the method includes: receiving accident data for notifying that an accident has occurred from a user terminal disposed inside a vehicle on which a user gets on; and transmitting accident notification data for notifying the accident occurrence to the preset accident response organization, wherein, when the accident occurrence is detected by the user terminal during monitoring a status of the vehicle and a presence of the accident occurrence, the accident data is transmitted from the user terminal to the vehicle accident notification server.

In addition, when a transmission-standby status maintaining time preset for waiting for data transmission is elapsed after the accident occurrence is detected, the accident data may be automatically transmitted from the user terminal to the vehicle accident notification server.

In addition, the accident data may be provided to be immediately transmitted through a manipulation of the user before the transmission-standby status maintaining time is elapsed.

According to the vehicle accident notification system and the method of providing a vehicle accident notification service of one embodiment of the present invention, when a vehicle accident occurs, the fact that the accident has occurred is notified from the user terminal to the vehicle accident notification server, and the vehicle accident notification server notifies the accident occurrence, so that a response to the accident can be rapidly performed.

In addition, according to one embodiment of the present invention, when a transmission-standby status maintaining time preset for waiting for transmitting data has elapsed upon occurrence of the accident, the accident can be automatically notified to the vehicle accident notification server so as to respond to the accident.

### BRIEF DESCRIPTION OF THE DRAWINGS

The above and other objects, features, and advantages of the present invention will be more apparent from the following detailed description taken in conjunction with the accompanying drawings, in which:

FIG. 1 is a view showing a vehicle accident notification system according to one embodiment of the present invention;

FIG. 2 is a block diagram showing a user terminal of FIG. 1;

FIG. 3 is a block diagram showing the configuration of a control unit in FIG. 2;

FIG. 4 is a block diagram showing a vehicle accident notification server of FIG. 1; and

FIG. 5 is a block diagram showing the configuration of a central processing unit in FIG. 4.

### DETAILED DESCRIPTION OF THE EXEMPLARY EMBODIMENTS

Hereinafter, exemplary embodiments of the present invention will be described in detail with reference to the accompanying drawings. However, the technical idea of the present invention is not limited to the exemplary embodiments described herein and may be embodied in other forms. Further, the embodiments are provided to enable contents disclosed herein to be thorough and complete and provided to enable those skilled in the art to fully understand the idea of the present invention.

In the specification herein, when one component is mentioned as being on other component, it signifies that the one component may be placed directly on the other component or a third component may be interposed therebetween. In addition, in drawings, thicknesses of layers and areas may be exaggerated to effectively describe the technology of the present invention.

In addition, although terms such as first, second and third are used to describe various components in various embodiments of the present specification, the components will not be limited by the terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it will be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, in the following description of the embodiments of the present invention, the detailed description of known functions and configurations incorporated herein will be omitted when it possibly makes the subject matter of the present invention unclear unnecessarily.

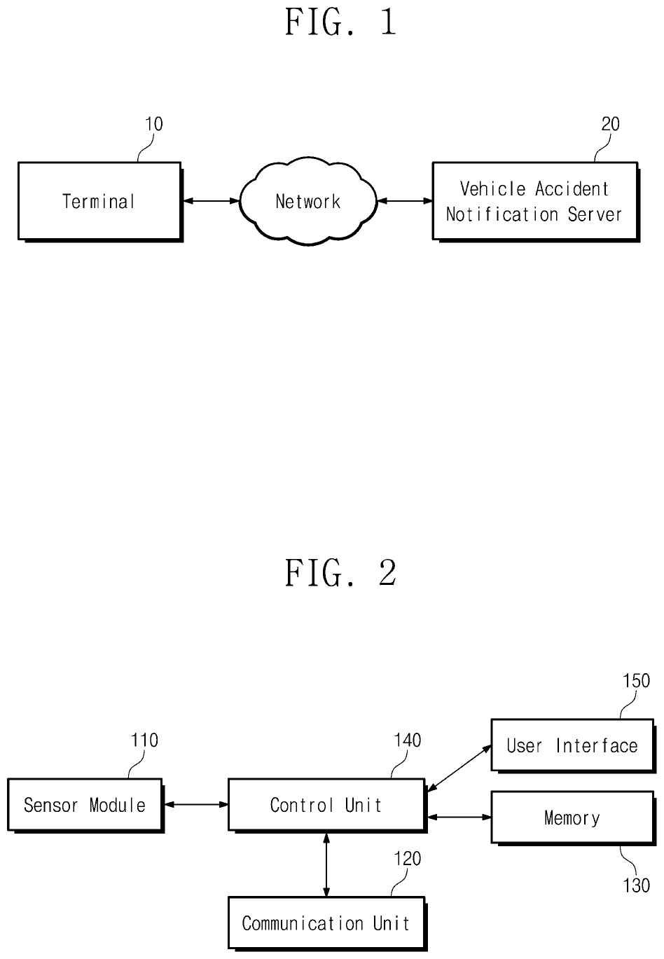

FIG. 1 is a view showing a vehicle accident notification system according to one embodiment of the present invention.

Referring to FIG. 1, the vehicle accident notification system according to one embodiment of the present invention includes a user terminal 10 and a vehicle accident notification server 20.

According to the vehicle accident notification system of one embodiment of the present invention, when an accident occurs in a vehicle on which a user gets, the accident occurrence is transmitted from the user terminal 10 to the vehicle accident notification server 20, the vehicle accident notification server 20 transmits the vehicle accident occurrence to a preset accident response organization such as an insurance company, an emergency rescue organization such as 911, a vehicle towing company, and other emergency contacts set by the user, so as to facilitate handling in response to the accident.

The vehicle accident notification server 20 and the user terminal 10 constituting the vehicle accident notification system may be connected to each other through a network. The network refers to a connection structure for allowing information exchange between nodes such as terminals and servers, and examples of the network include a 3rd generation partnership project (3GPP) network, a long term evolution (LTE) network, a world interoperability for microwave access (WIMAX) network, the Internet, a local area network (LAN), and a wireless local area network (Wireless LAN), a wide area network (WAN), a personal area network (PAN), a Bluetooth network, a satellite broadcasting network, an analog broadcasting network, a digital multimedia broadcasting (DMB) network, and the like, but are not limited thereto.

FIG. 2 is a block diagram showing a user terminal of FIG. 1.

Referring to FIG. 2, the user terminal 10 includes a sensor module 110, a communication unit 120, a memory 130, a control unit 140, and a user interface 150.

The user terminal 10 may include various types of terminals or electronic equipment, such as a mobile phone, a smart phone, and a tablet PC, capable of data communication via wired or wireless. The user terminal 10 may be provided while being carried by the user in the vehicle or mounted inside the vehicle.

The sensor module 110 is provided in the user terminal 10 to detect a change in movement state of the vehicle. The sensor module 110 may include a shock sensor module for detecting a shock applied to the vehicle. For example, the shock sensor module may be provided as an acceleration sensor. The acceleration sensor may be provided as a 3-axis acceleration sensor to detect an up-down shock amount, a front-rear shock amount, and a left-right shock amount. The acceleration sensor may be controlled such that sensitivity of a sensor value is adjusted according to the speed of the vehicle. The acceleration sensor may be controlled such that the sensitivity of the front-rear shock amount or the left-right shock amount is adjusted to be greater than the sensitivity of the up-down shock amount, so as to improve the discrimination of determination on the accident. For example, when a vehicle crosses a speed bump, the up-down shock amount of the vehicle is greater than the left-right shock amount or front-rear shock amount. Accordingly, in the case of a slow mode, the sensitivity of the up-down shock amount may be controlled to be set lower than the left-right shock amount or the front-rear shock amount.

In addition, the shock sensor module may include an acceleration sensor and a gyro sensor. Accordingly, the accuracy of detecting a state such as a speed change of the vehicle during driving, sudden braking of the vehicle, or sudden rotation or overturn of the vehicle due to a shock may be improved. For example, the type of overturn may be determined using changes in longitudinal speed and changes in lateral speed of the vehicle. In order to more accurately determine the type of overturn, at least one of a roll rate detected by the gyro sensor and a vertical acceleration detected by the acceleration sensor may be used for the determination. The type of overturn may be determined as a ramp mode when the vehicle turns while either a right or left side of the vehicle is driving on a ramp; a ditch mode when the vehicle enters and turns on a downward ramp such as a dike; a bump mode when the vehicle turns in the lateral direction on a stepped part such as a curb stone on the road; and a sand mode when the vehicle enters a road surface, such as a sandy road, having a large friction coefficient, and turns due to hindrance in the lateral direction, and may be determined as an auxiliary mode when it is not determined by any type among the above types of overturn determinations.

The sensor module 110 may include a position sensor module. The position sensor module detects changes in position of the vehicle. In addition, the speed of the vehicle may be calculated through the changes in position of the vehicle detected by the position sensor module. The position sensor module may be a GPS sensor.

The communication unit 120 may be provided to enable wireless data communication through the network, so as to transmit and receive data with the vehicle accident notification server 20.

The memory 130 may store various data such as a client program for using the vehicle accident notification service, data generated for operating the client program, data received from the vehicle accident notification server 20, and a detected value of sensor module 110. In addition, the memory 130 may store pattern information. The pattern information is provided in the form of a pattern of data for the basis of determining whether the vehicle has the accident. In addition, the pattern information may be updated through the data transmitted from the vehicle accident notification server. The pattern information includes shock amount pattern information. The shock amount pattern information is provided in a shock amount pattern form when the vehicle is in a normal state or an abnormal state. The shock amount pattern information may include the pattern forms of the up-down shock amount, the front-rear shock amount, and the left-right shock amount. In addition, the shock amount pattern information may include an inclination pattern form of a vehicle body in response to the detection value of the gyro sensor In addition, the shock amount pattern information may be provided in the form in which shock amount pattern forms are assigned according to the speeds of the vehicle, respectively. In addition, the pattern information may include sound pattern information. The sound pattern information is provided in a sound pattern form when the vehicle is in a normal state or an abnormal state. In addition, the sound pattern information may be provided in the form in which sound pattern forms are assigned according to the speeds of the vehicle, respectively. The memory 130 collectively refers to a non-volatile storage device configured to maintain stored information even when power is not supplied.

The control unit 140 may execute the client program stored in the memory 130, and apply the data received from the vehicle accident notification server 20, the data stored in the memory 130, and the data detected by the sensor module 110 to the program. The control unit 140 determines whether an accident has occurred in the vehicle through the data detected by the sensor module 110, and transmits corresponding accident data to the vehicle accident notification server 20 through the communication unit 120 when determining that the accident has occurred. The control unit 140 may control the client program to monitor the status and occurrence of the vehicle while being in a background executed state, so that accident data may be transmitted to the vehicle accident notification server 20 when the accident occurrence is detected.

The user interface 150 may include a display to display the state of the user terminal 10, the state of the client program and the like. In addition, the user interface 150 may include a touch panel, a keyboard and the like, so that the user may directly input data for manipulating the user terminal 10.

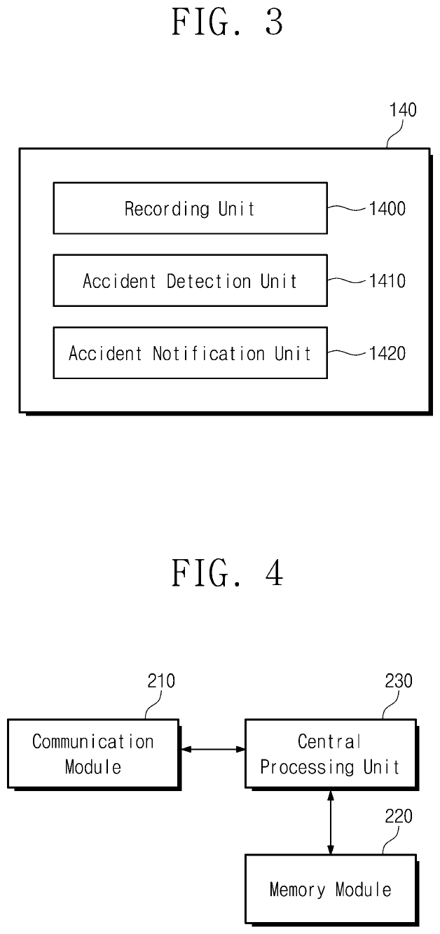

FIG. 3 is a block diagram showing the configuration of a control unit in FIG. 2.

Referring to FIG. 3, the control unit 140 includes a recording unit 1400, an accident detection unit 1410, and an accident notification unit 1420.

The recording unit 1400 records surrounding sounds. In other words, the recording unit 1400 may record sound generated by the vehicle while the vehicle is driving via a microphone provided in the user terminal 10 or connected to the user terminal 10, and may record crashing sounds and glass breakage sounds generated when the vehicle collides with another object in the event of an accident.

The accident detection unit 1410 detects the occurrence of accident by comparing the value detected by the sensor module 110 with the pattern information. Specifically, the accident detection unit 1410 may compare the value detected by the shock sensor module with the shock amount pattern information to determine that the accident has occurred when the matching degree is greater than or equal to a preset value. When the shock amount pattern information is assigned according to the speed of the vehicle, the accident detection unit 1410 may apply the speed of the vehicle detected through the position sensor module. In addition, the accident detection unit 1410 may be provided to receive the speed of the vehicle from a speedometer of the vehicle through the network and the communication unit 120, to apply the speed of the vehicle when comparing the value detected by the shock sensor module with the shock amount pattern information. In addition, the accident detection unit 1410 may additionally apply the degree of matching to the accident determination by comparing the sound stored through the recording unit 1400 with the sound pattern information.

The accident notification unit 1420 transmits the accident data to the vehicle accident notification server 20, when the accident detection unit 1410 determines that the accident has occurred. The accident data may include at least one of a current vehicle position detected by the position sensor at the time of transmitting the accident data, a value detected by the shock sensor module at the time when it is determined that the accident has occurred, and sound data recorded through the recording unit 1400 at the time when it is determined that the accident has occurred. When the accident detection unit 1410 detects that the accident has occurred, the accident notification unit 1420 may allow the accident data to be in a data transmission-standby state prior to transmitting the accident data, and transmit the accident data when a preset time elapses in the data transmission-standby state For example, the time for maintaining the transmission-standby state may be set as between 20 seconds and 40 seconds. In addition, the time for maintaining the transmission-standby state may be provided to be adjusted after the user executes the client program. In addition, during the data transmission-standby state, the user may set the accident data to be immediately transmitted through the interface, so that the accident data is transmitted before the preset time elapses in the data transmission-standby state. In addition, during the data transmission-standby state, the user may cancel the transmission of the accident data through the interface. The accident notification unit 1420, during the data transmission-standby state, may be set to display the execution status of the client program on the display, so as to enable the user to easily input the immediate transmission of the accident data or the cancellation of the accident data. In addition, the accident notification unit 1420 may simultaneously transmit data on whether the accident data is transmitted after the time for maintaining the transmission-standby state, or whether the accident data is transmitted by the user before the time for maintaining the transmission-standby state.

FIG. 4 is a block diagram showing a vehicle accident notification server of FIG. 1.

Referring to FIG. 4, the vehicle accident notification server 20 includes a communication module 210, a memory module 220 and a central processing unit 230. Components of the vehicle accident notification server 20 may be configured to be positioned in one physical space and directly connected to each other, or may be configured in the form of a system in which some of the components are positioned in different physical spaces and interconnected through a network.

The communication module 210 may be provided for wired and wireless data communication through the network to transmit and receive data with the user terminal 10. The communication module 210 may receive the accident data from the user terminal 10, and transmit the accident notification data to a server, terminal and the like of a related organization. The accident notification data refers to data that notifies the occurrence of the accident to insurance companies, emergency rescue agencies such as 911, vehicle towing companies, and other emergency contacts set by the user.

The memory module 220 may store received data, a program for providing a vehicle accident notification service, processing data generated by processing the received data, a program for performing an accident simulation and various other data. The memory module 220 collectively refers to a non-volatile storage device configured to maintain stored information even when power is not supplied.

The central processing unit 230 may execute the program stored in the memory module 220, and apply the saved data to the program. The central processing unit 230 may control the communication module 210 and the memory module 220, and may be construed as a processor capable of receiving a predetermined program through the communication module 210 or reading and processing data stored in the memory module 220.

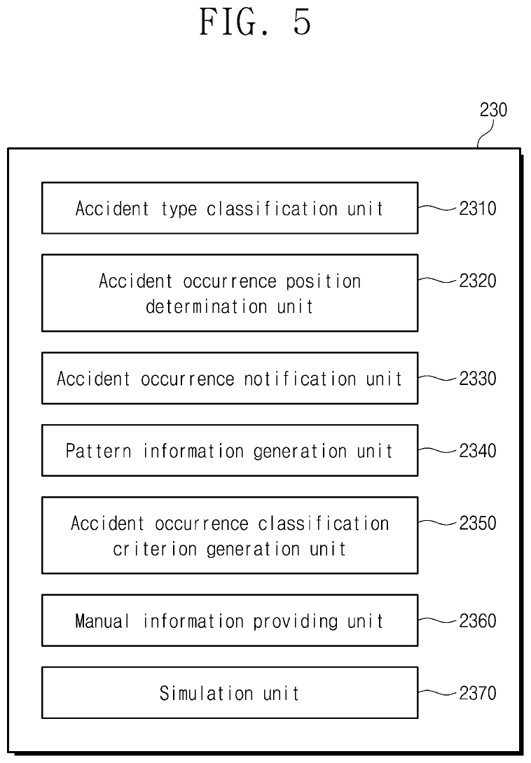

FIG. 5 is a block diagram showing the configuration of a central processing unit in FIG. 4.

Referring to FIG. 5, the central processing unit 230 includes an accident type classification unit 2310, an accident occurrence position determination unit 2320, an accident occurrence notification unit 2330, a pattern information generation unit 2340, an accident occurrence classification criterion generation unit 2350, a manual information providing unit 2360 and a simulation unit 2370.

The accident type classification unit 2310 classifies an accident type of the vehicle based on received accident data and preset accident type classification criteria. For example, the accident type classification unit 2310 may automatically classify the accident type as to whether the current vehicle accident is caused by signal violation, intersection violation, center line violation, sudden lane change, obstacle, parking terrorism or the like, or a simple minor collision, or whether the accident is caused by colliding with a two-wheeled vehicle or a person.

The accident occurrence position determination unit 2320 functions to identify the current accident occurrence position based on the received accident data. In other words, the accident occurrence position determination unit 2320 may identify the position of the accident through the current vehicle position detected by the position sensor at the time of transmitting the accident data included in the accident data.

The accident occurrence notification unit 2330 may transmit the accident notification data to a preset accident response agency. In other words, the accident occurrence notification unit 2330 may be provided to have URL addresses, phone numbers, and the like for transmitting the accident notification data to each of the insurance companies, emergency rescue agencies such as 911, vehicle towing companies, and other emergency contacts set by the user, so that the accident notification data may be transmitted to the organizations. The accident notification data transmitted to the organizations may be set to be identically or differently. The accident notification data may be provided to include the accident position information identified through the accident occurrence position determination unit 2320, so that the organization having received the accident notification data may effectively carry out rescue work according to the function of the corresponding organization. In addition, the accident notification data provided to the insurance companies may include insurance information of the driver.

The pattern information generation unit 2340 may generate a pattern between accident data and an actual occurrence of an accident. In other words, the pattern information generation unit 2340 defines the accident data as an input factor and defines the output of the accident detection unit 1410 as an output factor, and then derives a correlation between the input factor and the output factor, thereby generating pattern information. The pattern information generation unit 2340 may be implemented through deep learning based on deep neural networks, so as to derive the correlation between the input factor and the output factor. In addition, the pattern information generation unit 2340 may update existing pattern information through new pattern information. In the pattern information generation unit 2340, the updated pattern information may be transmitted to the user terminal 10 when the pattern information is updated, so that the accident detection unit 1410 may detect whether the accident has occurred by using the updated pattern information.

The accident occurrence classification criterion generation unit 2350 may generate accident type classification criteria. In other words, the accident occurrence classification criterion generation unit 2350 defines the accident data as an input factor and defines the output of the accident type classification unit 2310 as an output factor, and then derives a correlation between the input factor and the output factor, thereby generating the accident type classification criteria. In addition, the accident occurrence classification criterion generation unit 2350 may update existing accident type classification criteria through new accident type classification criteria. The accident occurrence classification criterion generation unit 2350 may be implemented through deep learning based on deep neural networks, so as to derive the correlation between the input factor and the output factor.

The manual information providing unit 2360 may transmit an accident response manual to the user terminal 10. The respond manual maybe provided in the form of text information displayed on the user terminal 10 or voice information outputted through a speaker provided to the user terminal 10. The respond manual may include, for example, notification information about a situation in which the accident notification data is notified to the preset organizations, notification information for guiding the user to photograph scenes of the accident for post-processing of the accident, and information for guiding the user to move to a safe place and await. When the accident data is automatically transmitted subject to the time for maintaining the transmission-standby state from the accident notification unit 1420 of the user terminal 10, may transmit a consciousness confirmation message for confirming whether the user is conscious to the user terminal 10. In addition, when a reply according to the consciousness confirmation message is not received within a preset period of time, the state that the user is losing consciousness may be transferred to the accident occurrence notification unit 2330, and the accident occurrence notification unit 2330 may additionally transmit an emergency message for informing the possibility of emergency to the preset organizations.

The simulation unit 2370 may perform a simulation using the accident data received from the user terminal 10. For example, the simulation unit 2370 may be provided to perform the simulation based on mathematical dynamic models (MADYMO) program. The simulation unit 2370 may function to analyze causes of the vehicle accident and determine a causal relationship of the injury through a three-dimensional simulation using the received accident data. Thereafter, the simulation results may be provided to an accident handling organization so as to accurately determine the situation. The simulation unit 2370 may be provided to pertain a simulation for each of different simulation conditions. In other words, the simulation unit 2370 includes various data necessary for analyzing occupant behaviors of the vehicle, such as data on a vehicle type and a vehicle structure thereby, data on a dummy used in an experiment, data on safety parts, data on vehicle motion properties upon collision. Preferably, the test conditions for each vehicle type may be provided in a database state, so that the simulation may be performed quickly for various vehicle types.

The vehicle accident notification system according to one embodiment of the present invention is provided such that an accident is detected through the user terminal 10 upon the accident, the accident occurrence is notified to the vehicle accident notification server 20, and then the accident occurrence is notified to the organizations and the like for handling the accident. Accordingly, the accident occurrence can be more quickly notified to the organizations and the accident can be handled, compared when the user personally notifies each of the organizations of the accident occurrence for handling the accident. In particular, in consideration of the driver embarrassed upon occurrence of an accident, the vehicle accident notification system according to one embodiment of the present invention can facilitate the remarkably quick accident notification and accident handling.

In addition, according to the vehicle accident notification system of one embodiment of the present invention, the accident occurrence is notified to the organizations for responding to the accident even when the driver loses consciousness due to the accident, so that the accident occurrence can be notified and the driver can be rescued quickly even when the driver loses consciousness due to the accident.

Although the present invention has been described in detail by using exemplary embodiments, the scope of the present invention is not limited to the specific embodiments, and shall be interpreted by the appended claims. In addition, it will be apparent that a person having ordinary skill in the art may carry out various deformations and modifications for the embodiments described as above within the scope without departing from the present invention.

What is claimed is:

1. A vehicle accident notification system for notifying an occurrence of an accident to a preset accident response organization upon the accident, the vehicle accident notification system comprising:
a user terminal that transmits accident data for notifying that a user is positioned inside a vehicle and an accident has occurred; and
a vehicle accident notification server that receives the accident data to transmit accident notification data for notifying the accident occurrence to a preset accident response organization, wherein,
when the accident occurrence is detected during monitoring a status of the vehicle and a presence of the accident occurrence, the user terminal transmits the accident data to the vehicle accident notification server.

2. The vehicle accident notification system of claim 1, wherein, when a transmission-standby status maintaining time preset for waiting for data transmission is elapsed after the accident occurrence is detected, the user terminal is provided to transmit the accident data.

3. A method of providing a vehicle accident notification service to transmit a vehicle accident occurrence to a preset accident response organization by using a vehicle accident notification server, the method comprising:
receiving accident data for notifying that an accident has occurred from a user terminal disposed inside a vehicle on which a user gets on; and
transmitting accident notification data for notifying the accident occurrence to the preset accident response organization, wherein,
when the accident occurrence is detected by the user terminal during monitoring a status of the vehicle and a presence of the accident occurrence, the accident data is transmitted from the user terminal to the vehicle accident notification server.

4. The method of claim 3, wherein, when a transmission-standby status maintaining time preset for waiting for data transmission is elapsed after the accident occurrence is detected, the accident data is automatically transmitted from the user terminal to the vehicle accident notification server.

5. The method of claim 4, wherein the accident data is provided to be immediately transmitted through a manipulation of the user before the transmission-standby status maintaining time is elapsed.
